(19) United States
(12) Patent Application Publication
(10) Pub. No.: US 2019/0203475 A1
(43) Pub. Date: Jul. 4, 2019

(54) SKYLIGHT DIFFUSER ACCESSORY

(71) Applicant: VKR HOLDING A/S, Horsholm (DK)

(72) Inventor: Brian Jefferson Burkes, Greenwood, SC (US)

(21) Appl. No.: 16/239,844

(22) Filed: Jan. 4, 2019

Related U.S. Application Data
(60) Provisional application No. 62/709,062, filed on Jan. 4, 2018.

(51) Int. Cl. E04D 13/03; G02B 5/02; G02B 27/09

(52) U.S. Cl. CPC E04D 13/033; E04D 2013/0345; G02B 27/0955; G02B 5/0205

(57) ABSTRACT

A skylight system for a building is provided that includes an upper cover, an interior diffuser that resides below the cover and includes a lens, and a diffuser accessory. The diffuser accessory is carried by the lens, is detachable from the lens, and imparts a degree of translucency, a color, and/or texture to light traveling through it. The diffuser accessory may be a flexible substrate or film, or may be a rigid member, and may adhere to the lens, may be re-attachable to the lens, and may be carried upon either the upper or lower lens surface. The diffuser is both detachable from and re-attachable to the remaining skylight system, for example by threads. The lens and the diffuser frame may be integral.

### CROSS REFERENCE TO RELATED APPLICATIONS

This application claims the benefit of priority of U.S. Provisional Application Ser. No. 62/709,062, filed on Jan. 4, 2018, which is incorporated herein in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIALS SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR A JOINT INVENTOR

Not applicable.

### BACKGROUND OF THE INVENTION

### Field of the Invention

The current invention relates to an accessory for skylight diffusers. More specifically, the current invention is directed to an interchangeable skylight diffuser accessory that imparts translucency, color, and/or texture to light conveyed by a skylight system.

### Description of the Related Art

Skylights provide natural light to the interior of a building by capturing daylight at an exterior cover and conveying that light through a light shaft and through a diffuser system into a building interior.

The diffuser system is often mounted at the interior end of the light shaft, upon a building interior ceiling, and includes a diffuser lens and a diffuser frame outboard of the diffuser lens. The diffuser system may achieve at least three purposes: (1) it may scatter the light entering the room through the skylight into a more aesthetically pleasing array; (2) it may conceal internal structural details of the skylight from normal viewing angles within the building interior; and (3) it may provide an attractive interior termination to the skylight.

The diffuser frame may also conceal unattractive irregularities in the ceiling opening that was created to allow passage of the skylight, and it may also provide an ornamental border around the diffuser lens.

The diffuser lens may be transparent, or it may be more translucent or less translucent. The diffuser lens may be frosted, prismatic, refracting, redirecting, of Fresnel configuration, of micro-Fresnel configuration, honeycomb, “egg crate” shaped, “cracked ice” formed, or of a multitude of other constructions to impart a “texture” to light having passed through such a diffuser lens. The diffuser lens may be colored to any hue of the visible spectrum. And the diffuser lens may be of a combination of two or more of the foregoing arrangements based on purpose, preference, and/or aesthetic choices.

Examples of skylight diffuser systems are disclosed in the present assignee's U. S. Pat. Nos. 9,702,149 and D793,579, the full disclosures of both of which are incorporated herein by reference.

Unfortunately, if a particular transparency or translucency, or a particular texture, or a particular color is imparted by the diffuser lens itself, a manufacturer would have to provide, and a retailer would need to stock, a multitude of different lens styles, each style having a multitude of lenses of different transparencies/translucencies, each style and transparency/translucency combination having a multitude of lenses each of a different texture, and each style and each transparency/translucency combination with each of the different textures having a multitude of lenses each of a different color. The permutations of such variables would require a large number of different lens configurations. And, after purchase and installation of a particular skylight system, changing only the transparency or translucency, or only the texture, or only the color would require replacement of at least the diffuser lens, if not the entire diffuser system.

Considering the foregoing, it would be advantageous to provide a diffuser system that would allow imparting different transparencies/translucencies, colors, and/or textures to a diffuser system. It would be further advantageous to provide for an accessory that could be located within a diffuser system to advantageously impart different transparencies/translucencies, colors, and/or textures to the light passing through the diffuser system. Still further, it would be advantageous to provide for interchangeable and stackable diffuser accessories to enable changing the transparencies/translucencies, colors, and/or textures of the light passing through the diffuser system after the installation of a skylight system, and without replacing the diffuser lens or the diffuser system in its entirety.

Accordingly, there is a need for a more convenient, interchangeable, stackable diffuser system that can provide alternative transparencies/translucencies, textures, and color options at the point of purchase or even after the purchase and installation of a skylight system.

### BRIEF SUMMARY OF THE INVENTION

In response to the discussed difficulties and problems encountered before, a new skylight diffuser accessory has been discovered.

The following presents a simplified summary of the invention in order to provide a basic understanding of some aspects of the invention. This summary is not an extensive overview of the invention. It is not intended to identify key or critical elements of the invention or to delineate the scope of the invention; its purpose instead is to present concepts of the invention in a simplified form as a prelude to the more detailed description that is subsequently presented.

As used herein, the term “upper” refers to a direction toward the sky and away from a building interior. The term “lower” refers to the direction opposite “upper.” The term “translucent” means semitransparent, and is the physical property of allowing light to pass through a material but with reduction. Less translucent material allows more the light to pass and more translucent material allows less light to pass. The term “transparent” is the physical property of allowing light to pass through a material without being scattered or reduced. The terms “comprise” and “comprising” specify the presence of stated features, integers, steps, or components but does not preclude the presence or addition of one or more other features, integers, steps, components, or groups thereof.

In accordance with certain aspects of certain embodiments of the present technology, a skylight system for a building is provided that includes a diffuser disposed at a building interior. The diffuser includes a lens and a diffuser accessory. The diffuser accessory is carried by the lens, may be removed from the lens, is light transmissive, and imparts at least one of a degree of translucency, a color, and a texture to light traveling through it. The diffuser accessory may re-attachable to the lens, and may be carried upon the upper surface or the lower surface of the lens. The diffuser may be both detachable from and re-attachable to the remaining skylight system, and may attach with the skylight system by threads. The skylight system may also include a diffuser frame, and in some applications the diffuser frame and the lens may be integral. In particular applications, plural diffuser accessories may be stacked upon one another, to impart at least two of a degree of translucency, a color, and a texture to light traveling through them.

In accordance with additional aspects of other embodiments of the present technology, a skylight system for a building is provided. The skylight system includes an upper cover, and interior diffuser, and a first diffuser accessory. The interior diffuser resides below the cover and includes a first lens. The diffuser accessory is carried by the first lens, is detachable from the first lens, is light transmissive, and imparts to light traveling through it at least one of a degree of translucency, a color, and a texture. The first diffuser accessory may adhere to the first lens. The skylight system may also include a second lens, the second lens being disposed between the first lens and the cover. The second lens may carry a second diffuser accessory, the second diffuser accessory that may be detachable from the first lens, be light transmissive, and impart to light traveling through it at least one of a color and a texture. The first diffuser accessory may be a flexible substrate and, in some embodiments, may be a film. In particular applications, plural diffuser accessories may be stacked upon one another upon a single lens, to impart at least two of a degree of translucency, a color, and a texture to light traveling through them.

In accordance with yet additional aspects of other embodiments of the present technology, a skylight system for a building is provided that has a cover on the building roof and an interior diffuser system. The diffuser system includes a first lens and a frame residing outboard of the first lens. The first lens defines a first perimeter. A first diffuser accessory is also included, and defines a second perimeter that is substantially equal to the first perimeter of the first lens. The first diffuser accessory is carried by the first lens, is detachable from it, is light transmissive, and imparts at least one of a color and a texture to light traveling through it. In particular applications, plural diffuser accessories may be stacked upon one another upon the first lens, to impart at least two of a degree of translucency, a color, and a texture to light traveling through them. The diffuser system may removably attached to the remaining skylight system, and in some of such embodiments may also be re-attachable to it. The diffuser system may carry male threads that are engageable with the remaining skylight system, thereby attaching the diffuser system to the skylight system. In some applications, the first lens and the frame are integral. A light shaft may be disposed between the cover and the diffuser, and may convey light from the cover to the diffuser. In some situations, a second lens may also be included, the second lens being carried by the diffuser system and residing between the first lens and the cover. In particular applications, a first diffuser accessory may be disposed upon the first lens and a second diffuser accessory may be disposed upon the second lens, to impart at least two of a degree of translucency, a color, and a texture to light traveling through them.

Further features of the present invention will be will be apparent from the description that follows and the appended drawings, or may be learned by practice of the invention. Both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

A full and enabling disclosure of the present invention, directed to one of ordinary skill in the art, is set forth in the specification that makes reference to the appended figures, in which:

FIG. 1 is an elevation view of a skylight, installed in a building, according to an embodiment of the present invention;

FIG. 2 is a perspective view of a diffuser accessory in accordance with an embodiment of the present invention;

FIG. 3 is a perspective view of a diffuser accessory in accordance with an embodiment of the present invention;

FIG. 4 is a section view, taken at A:A in FIG. 1, of a diffuser system according to an embodiment of the present invention

FIG. 5 is a perspective view of a diffuser system in accordance with an embodiment of the present invention;

FIG. 6 is a section view, taken at A:A in FIG. 1, of a diffuser system according to an embodiment of the present invention

FIG. 7 is a section view, taken at A:A in FIG. 1, of a diffuser system according to an embodiment of the present invention

FIG. 8 is a section view, taken at A:A in FIG. 1, of a diffuser system according to an embodiment of the present invention

It should be noted that the drawings discussed above and below are not to scale in all instances, but may have exaggerated dimensions in some respects to illustrate principles of the invention.

### DETAILED DESCRIPTION OF REPRESENTATIVE EMBODIMENTS

The present invention may be understood more readily by reference to the following detailed description, examples, drawings, and claims. However, it is to be understood that this invention is not limited to the specific devices, systems, and/or methods disclosed, as such can, of course, vary. It is also to be understood that the terminology used herein is for the purpose of describing particular aspects only and is not intended to be limiting.

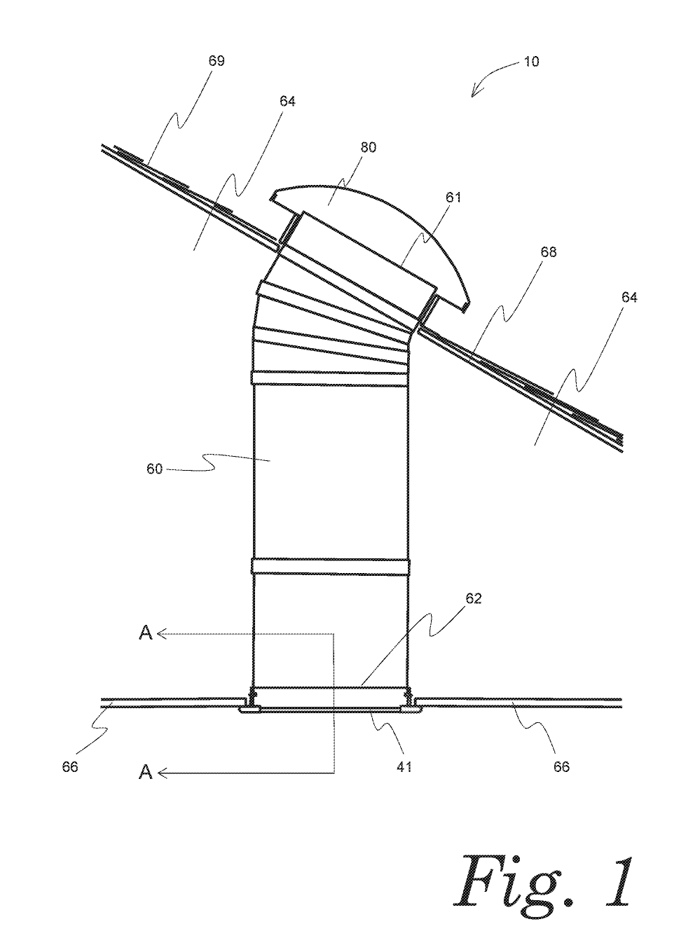

FIG. 1 illustrates an embodiment of a skylight system 10 according to the present invention and installed in a building. The skylight system 10 includes a cover 80, a light shaft 60, and an interior lens 41 of a diffuser system 11. The skylight system 10 is illustrated as installed through a building roof 68 and through a building interior ceiling 66. Roof 68 is illustrated in FIG. 1 as inclined, but flat roofs 68 are encountered as well, and the skylight system 10 performs equally well with either roof configuration. Between roof 68 and ceiling 66 may reside an attic space 64 in some applications, and skylight system 10 is illustrated to traverse attic space 64 by light shaft 60. In other applications, no attic space 64 may be encountered, and light shaft 60 may instead reside between cover 80 and ceiling 66 such as, for example, across the dimension of roof rafters or roof trusses (not shown). In general, light shaft 60 may be understood to be that portion of a skylight system 10 that resides between a cover 80 and a diffuser interior lens 41. Light shaft 60 transports light from cover 80 to diffuser interior lens 41.

The cover 80 resides on skylight system 10 on the exterior of roof 68 with shingles 69. Cover 80 as illustrated in FIG. 1 is a dome, but pyramidal covers 80, planar covers 80, inclined covers 80, and flat covers 80 may be used with the present invention as well. Cover 80 receives exterior light, such as sunlight, and conveys that light into light shaft 60.

Light shaft 60 may be constructed of plaster board, other wallboard, or similar material. Alternatively, light shaft 60 may be made of metal, plastic, and/or other materials. Light shaft 60 may be tubular in some applications.

Light shaft 60 may be understood to have one end, denominated herein as upper end 61, located proximate to cover 80 and an opposite end, denominated herein as lower end 62, located proximate to ceiling 66 and to interior diffuser lens 41.

Diffuser lens 41 resides at lower end 62 of skylight system 10. Diffuser lens 41 is illustrated in FIG. 1 as planar, and as parallel with the plane of ceiling 66, but other configurations may be used in particular applications without departing from the present invention. Diffuser lens 41 conveys light received from light shaft 60 into the interior of the building.

Diffuser lens 41 may be carried by, or alternatively may carry, a frame 50. Frame 50 may conceal irregularities in the opening to ceiling 66 that was created to allow passage of the skylight system 10, and may also provide an orderly and ornamental border at the diffuser lens 41.

Diffuser lens 41 may be attached, directly or indirectly, to lower end 62, or to ceiling 66. In some applications, a mount 30 may be used to attach, directly or indirectly, interior lens 41 to lower end 62. Similarly, in some applications a frame 50 may surround part or the entirety of the perimeter of interior lens 41. Frame 50 may attach to the skylight system 10 at interior lens 41, at mount 30, to ceiling 66, or to light shaft 60. At least the interior lens 41 may be understood to be comprised by a diffuser system 11; in those applications in which a frame 50 is used, diffuser system 11 comprises both interior lens 41 and frame 50.

In certain circumstances, additional diffuser lenses may be employed, such as for example second lens 42 and, optionally, third lens 43. Second lens 42 may reside between interior lens 41 and cover 80, and third lens 43 may reside between second lens 42 and cover 80. The use of a second lens 42 may improve the thermal insulation properties of skylight system 10, reducing heat transfer through skylight system 10.

The present invention discovers the use of a diffuser accessory 20. Diffuser accessory 20 may be a film that is applied to a surface, such as the upper surface 44 or the lower surface 45 of interior lens 41. Alternatively, diffuser accessory 20 as a film may be applied to either surface of second lens 42 and/or third lens 43. In a different embodiment, diffuser accessory 20 may be a flexible substrate that is layered above upper surface 44 of interior lens 41 (or upon second lens 42 and/or third lens 43). In a still further different embodiment, diffuser accessory 20 may be a rigid member that may be placed upon the top of interior lens 41, second lens 42, or third lens 43. Diffuser accessory 20 imparts an optical property (as explained in more detail above and below) to light passing through skylight system 10 including through interior lens 41 (and, optionally, second lens 42 and third lens 43).

Diffuser accessory 20 may define a perimeter that is substantially equal to the perimeter of interior lens 41, second lens 42, or third lens 43, such that the optical properties of diffuser accessory 20 are imparted to the entirety of light passing through skylight system 10 including through interior lens 41.

Whether a film, flexible substrate, or rigid member, diffuser accessory 20 may be configured to have preselected optical properties. For examples, diffuser accessory 20 may be more translucent or less translucent. Diffuser accessory 20 also may be frosted, prismatic, refracting, redirecting, of Fresnel configuration, of micro-Fresnel configuration, honeycomb, “egg crate” shaped, “cracked ice” formed, or of a multitude of other constructions to impart a “texture” to light having passed through such a diffuser lens. Diffuser accessory 20 also may be colored to any hue of the visible spectrum.

Multiple diffuser accessories 20 may be utilized in a single skylight system 10. For example, a more translucent first diffuser accessory 20 may be disposed upon an interior lens 41 to scatter less the light conveyed by a particular skylight system 10. Second, a honeycomb second diffuser accessory 20 may be disposed upon the first diffuser accessory 20, to impart a desired texture to the light conveyed by that particular skylight system 10. Still further, a blue colored third diffuser accessory 20 may be disposed atop the second diffuser accessory 20, to impart a blue hue to the light conveyed by that particular skylight system 10. The foregoing combinations are exemplary only, as a multitude of different translucency, color, and texture combinations are possible with the present invention.

In an installed skylight system 10 in a building, interior lens 41 may be removably attached, directly or indirectly, to lower end 62, or to ceiling 66, such that a particular diffuser accessory 20 may be interchanged with a different diffuser accessory 20 having different optical properties. For example, an interior lens 41 with a frame 50 may be removably attached to a mount 30, such that the combination, diffuser system 11, may be removed from the skylight system 10 to allow for changing (or adding to) a particular diffuser accessory 20. In some applications, diffuser system 11 may attach to skylight system 10 with threads 52 that allow for the removal of diffuser system 11 and thereby the changing of a particular diffuser accessory 20 to a different diffuser accessory 20.

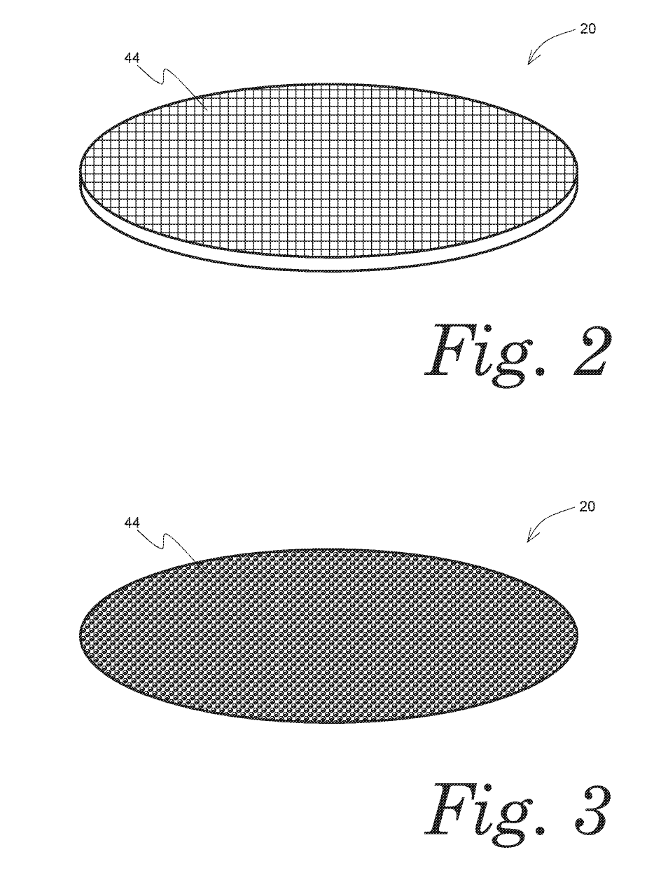

Various aspects of the present invention are further revealed in the other appended figures. For example, FIG. 2 illustrates a diffuser accessory 20 that is a rigid member. Diffuser accessory 20 of FIG. 2 has a particular translucency, a configuration that will impart a particular texture to light passing therethrough, and a particular color. By comparison, the diffuser accessory of FIG. 3 is a flexible substrate having a different translucency, a different configuration to impart a different texture to light passing therethrough, and a different color. The diffuser accessory 20 of FIGS. 2 and 3 are illustrated as being circular, for use in a circular interior lens 41, but other perimeter configurations may be used, for example a rectangular perimeter for use with rectangular diffuser lenses 41.

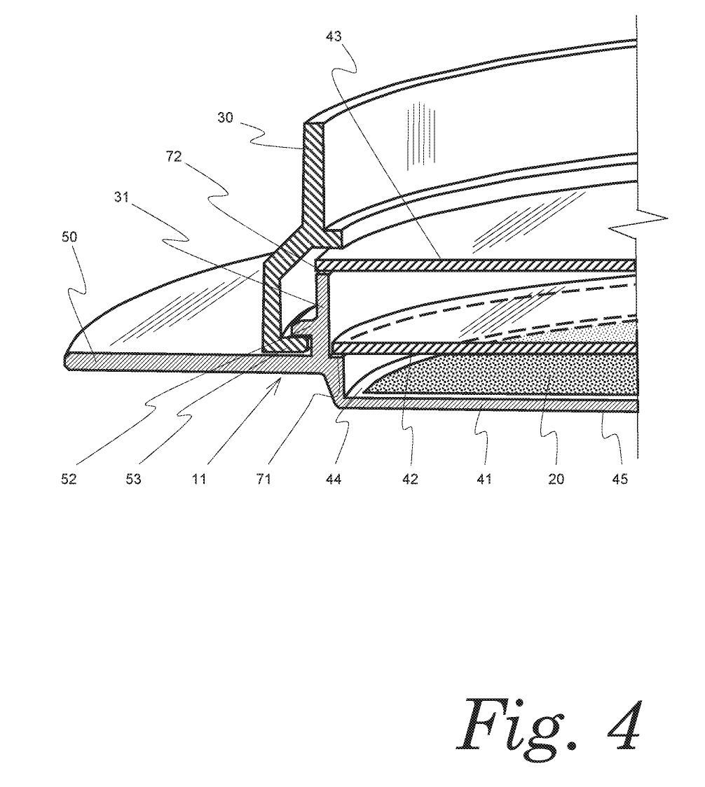

FIG. 4 is a section view of a diffuser system 11 according to one embodiment of the present invention. As illustrated in FIG. 4, interior lens 41 resides beneath second lens 42, and interior lens 41 and second lens 42 reside beneath third lens 43. Second lens 41 is shown to rest upon a first shelf 71, and third lens 43 is shown to rest upon a second shelf 72. A mount 30 is also illustrated in FIG. 4. Diffuser system 11, which includes interior lens 41, second lens 42, third lens 43, and frame 50, is shown mounted to mount 30 by means of first thread 52 engaging with second thread 53. In the illustrated embodiment, diffuser system 11 also includes a ring 31, projecting upward from interior lens 41. In the embodiment illustrated in FIG. 4, frame 50 and interior lens 41 are integral, although such is not necessary for the present invention—interior lens 41 may be of a separate material and/or component from frame 50 in other applications. In the embodiment illustrated in FIG. 4, diffuser accessory 20 is shown to reside upon the upper surface 44 of interior lens 41. Also in the illustrated embodiment of FIG. 4, second lens 42 and third lens 43 do not carry a diffuser accessory 20, although optionally additional diffuser accessories 20 might be added to second lens 42 and/or third lens 43.

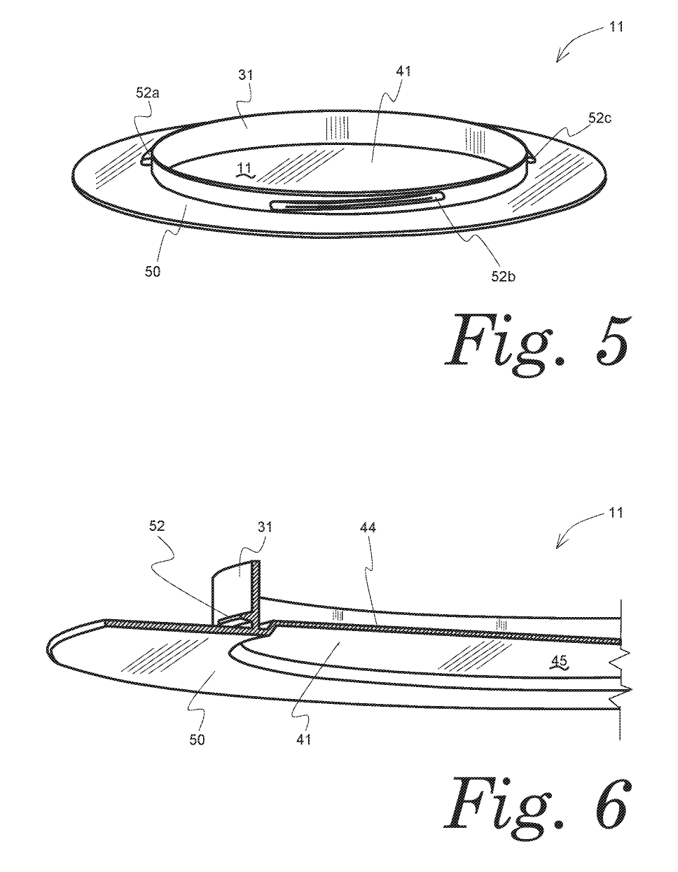

FIG. 5 illustrates another embodiment of a diffuser system 11. As illustrated therein, diffuser system 11 includes interior lens 41, frame 50, first threads 52a, b, c, and ring 31.

FIG. 6 illustrates another embodiment of diffuser system 11, in the embodiment illustrated in FIG. 6, diffuser system 11 includes ring 31, first thread 52 for attachment of diffuser system 11 to skylight system 10, frame 50, and interior lens 41. As illustrated in FIG. 6, an embodiment of the present invention includes a configuration which the plane of interior lens 41 resides above frame 50. Interior lens 41 is disposed for receipt of one or more diffuser accessories 20 in FIG. 6.

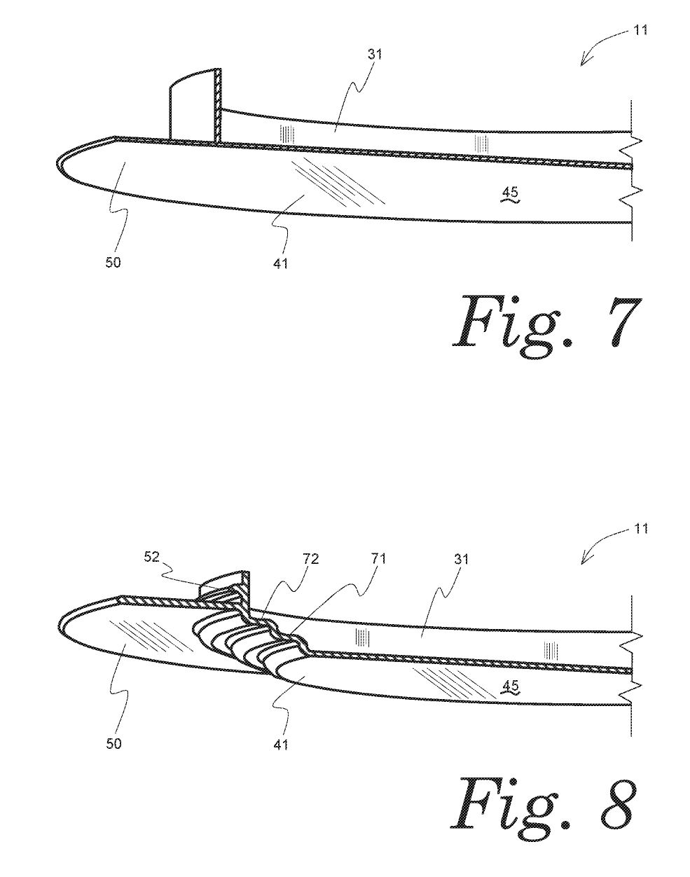

FIG. 7 illustrates a different embodiment of a diffuser system 11. In the embodiment illustrated in FIG. 7, interior lens 41 and frame 50 are both integral and co-planer. Also illustrated in FIG. 7 is optional ring 31. Interior lens 41 is disposed for receipt of one or more diffuser accessories 20 in FIG. 7.

Finally, a still further embodiment of diffuser system 11 is illustrated in FIG. 8. In the embodiment illustrated in FIG. 8, the plane of interior lens 41 is shown to reside below frame 50. Ring 31 is also included in this embodiment, which resides first thread 52 for attachment of diffuser system 11 to skylight system 10. Further included in the embodiment of FIG. 8 are first shelf 71 and second shelf 72. In such and embodiment, first shelf 71, and likewise second shelf 72, may be configured for receipt of a second lens 42 and a third lens 43, respectively, of diffuser accessory 20. Also illustrated in FIG. 8 is a frame 50 and an interior lens 41 that are integral, although the present invention further contemplates that frame 50 may be of a separate and/or different material than interior lens 41.

The foregoing description has been presented for purposes of illustration and description. It is not intended to be exhaustive or to limit the invention to the precise form disclosed. Modifications, variations, or combination of embodiments are possible in light of the above teachings. The exemplary embodiments were chosen and described to provide an illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

While this invention has been described in conjunction with the specific embodiments outlined above, many alternatives, modifications, and variations will be understood to those skilled in the art. Accordingly, the exemplary embodiments of the invention, as set forth above, are intended to be illustrative, not limiting. Various changes may be made without departing from the spirit and scope of this invention.

An Abstract is provided with this disclosure, as required. The purpose of the Abstract is to enable the various Patent Offices and the public generally, and especially practitioners in the art who are not familiar with patent or legal terms or phraseology, to determine quickly from a cursory inspection the nature and essence of the technical disclosures of the application. The Abstract is not intended to be limiting as the scope of the invention in any way.

1. A skylight system for a building, comprising:
a diffuser, the diffuser disposed at the building interior, the diffuser including a lens;
a diffuser accessory, the diffuser accessory:
being carried by the lens;
being removable from the lens;
being light transmissive; and
imparting to light traveling through it at least one of a degree of translucency, a color, and a texture.

2. The skylight system of claim 1, wherein the diffuser accessory is re-attachable to the lens.

3. The skylight system of claim 1, wherein the lens has an upper surface and a lower surface, and the diffuser accessory is carried upon the upper surface.

4. The skylight system of claim 1, wherein the lens has an upper surface and a lower surface, and the diffuser accessory is carried upon the lower surface.

5. The skylight system of claim 1, wherein the diffuser is both detachable from and re-attachable to the remaining skylight system.

6. The skylight system of claim 5, in which the diffuser attaches with the skylight system by threads.

7. The skylight system of claim 1, further including a diffuser frame, in which the lens and the diffuser frame are integral.

8. A skylight system for a building, comprising:
an upper cover;
an interior diffuser, the diffuser:
residing below the cover; and
including a first lens;
a first diffuser accessory, the first diffuser accessory:
being carried by the first lens;
being detachable from the first lens;
being light transmissive; and
imparting to light traveling through it at least one of a degree of translucency, a color, and a texture.

9. The skylight system of claim 8, wherein the first diffuser accessory adheres to the first lens.

10. The skylight system of claim 8, wherein the diffuser includes a second lens, the second lens being disposed between the first lens and the cover.

11. The skylight system of claim 10, wherein the second lens carries a second diffuser accessory, the second diffuser accessory:
being detachable from the first lens;
being light transmissive; and
imparting to light traveling through it at least one of a color and a texture.

12. The skylight system of claim 8, wherein the first diffuser accessory is a flexible substrate.

13. The skylight system of claim 8, wherein the first diffuser accessory is a film.

14. A skylight system for a building, comprising:
a cover, the cover disposed on the building roof;
an interior diffuser system, the diffuser system including a first lens and a frame, the frame residing outboard of the first lens;
the first lens defining a first perimeter;
a first diffuser accessory, the first diffuser accessory:
defining a second perimeter, the second perimeter substantially equal to the first perimeter;
being carried by the first lens;
being detachable from the first lens;
being light transmissive; and
imparting to light traveling through it at least one of a degree of translucency, a color, and a texture.

15. The skylight system of claim 14, in which the diffuser system is removably attached to the remaining skylight system.

16. The skylight system of claim 15, in which the diffuser system is also re-attachable to the skylight system.

17. The skylight system of claim 16, in which the diffuser system carries male threads the male threads being engageable with the remaining skylight system thereby attaching the diffuser system to the skylight system.

18. The skylight system of claim 14, in which the first lens and the frame are integral.

19. The skylight system of claim 14, further including a light shaft that is disposed between the cover and the diffuser and conveys light from the cover to the diffuser.

20. The skylight system of claim 14, further including a second lens, the second lens carried by the diffuser system and residing between the first lens and the cover.
